(19) United States
(12) Patent Application Publication
(10) Pub. No.: US 2016/0045288 A1
(43) Pub. Date: Feb. 18, 2016

(54) DENTAL IMPLANT PACKAGE

(71) Applicants: Chien-Chou LIN, Taipei City (TW); Wu-Hsiung LIN, Taipei City (TW); Hsiao-Shen MEI, Taipei County (TW); Li-Tien WANG, New Taipei City (TW)

(72) Inventors: Chien-Chou LIN, Taipei City (TW); Wu-Hsiung LIN, Taipei City (TW); Hsiao-Shen MEI, Taipei County (TW); Li-Tien WANG, New Taipei City (TW)

(21) Appl. No.: 14/828,643

(22) Filed: Aug. 18, 2015

(30) Foreign Application Priority Data
Aug. 18, 2014 (TW) 103214703

(51) Int. Cl. A61C 8/00

(52) U.S. Cl. CPC A61C 8/008; A61C 8/0022; A61C 8/006; A61C 8/0016; A61C 8/0068; A61C 8/0053

(57) ABSTRACT

The present invention provides a dental implant package, comprising a healing abutment and a tooth-replacement implant. The healing abutment made of plastic materials and rubber material comprises a tooth-replacement implant cap and a first insertion; wherein the tooth-replacement implant cap including a first main body and a first groove is a polygonal prism with different sectional areas of upper level greater than low level and located in the first main body, and an external surface of the first insertion has a plane surface and a first fine thread. Further, an external surface of the tooth-replacement implant has an external thread section and circular arc thread section, and inside of the tooth-replacement implant has an internal thread section; wherein the first insertion is made of plastic materials or rubber materials; alternatively, the first insertion may be consisted by embracing a first metal screw with plastic materials or rubber materials.

### CROSS REFERENCE TO RELATED APPLICATION

This application claims the benefits of the Taiwan Patent Application Serial Number 103214703, filed on Aug. 18, 2014, the subject matter of which is incorporated herein by reference.

### BACKGROUND OF THE INVENTION

1. Field of the Invention

The present invention relates to a dental implant package, and more particularly to a dental implant package capable of adjusting its height and width by a general drilling tool and adding materials to obtain an emergency profile.

2. Description of Related Art

The number of the implants is up to 300,000 every year in Taiwan, and there are tens of products of the tooth-replacement implants in the market. The tooth-replacement implant is an endosseous implant, which is made generally from pure titanium or titanium alloy, and implanted in bones of upper arch or lower arch by an operation to provide a support for artificial tooth and recover a mastication function.

Besides, whether the operation for dental implant is successful or not, there are many reasons that we need to take into account, such as a sclerotin, a bone mass, a geometrical shape of the implant, surface properties and so on. Therefore, the osseointegration of the tooth-replacement implant in the alveolus and stability of the tooth-replacement implant under the load of mastication are quite important. As a result, many researches relate to the surface structure of the tooth-replacement implant and therapeutic methods to improve bone healing and stability of the implant in an early stage.

In an operation for implanting a tooth-replacement implant, first, the tooth-replacement implant is implanted in the alveolus bone and inserted a cover screw, and then sutured gingival to accomplish osseointegration of the tooth-replacement implant. In the second stage of the restorative tooth-replacement implant, a healing abutment which is usually a cone-shaped abutment or a screw-shaped abutment must be inserted in the tooth-replacement implant of the alveolar bone. The subjects of the healing abutment used in the tooth-replacement implant are that gingival tissue is healed according to the profile of the healing abutment; alternatively, an enough space is maintained to insert a definitive prosthesis. Besides, a provisional crown can be inserted directly in the tooth-replacement implant when a patient has a good dental situation, so that the patient can maintain normal eating. The used healing abutment is usually made of Titanium Grade 5 on the market; however, it is not very ideal that the titanium metal is difficult to correct its shape and has high cost resulted in enhancement of total cost. Further, the titanium metal is easily recovered and reused; therefore, a problem of cross-infection is made.

Therefore, there is an urgent need for a dental implant package, which can be correct its shape by general drilling tools and adding materials. The dental implant package cannot only be adjusted to proper heights, widths and shapes, but also obtain an emergency profile to solve problems of well-known technology.

### SUMMARY OF THE INVENTION

An object of the present invention is to provide a dental implant package capable of correcting its shape, which can be clinically corrected by general drilling tools and adding materials to adjust to proper heights, widths and shapes, thereby obtaining an emergency profile or maintaining an enough space to insert a definitive prosthesis.

Another object of the present invention is to provide a dental implant package capable of correcting its shape, which has high biocompatibility, high mechanical strength, high hardness and excellent attachment with 3T3 fibroblast in gingival, thereby accelerating wound healing.

To achieve above object, the present invention is to provide a dental implant package, comprising a healing abutment and a tooth-replacement implant; wherein the healing abutment which is made of plastic materials or rubber materials comprises a tooth-replacement implant cap and a first insertion. Further, the tooth-replacement implant cap can comprise a first main body and a fist groove which is a polygonal prism with different sectional areas of upper level greater than low level and located in the main body, and an external surface of the first insertion may have a plane section and a first fine thread section. Besides, an external surface of the tooth-replacement implant has the external thread section and a circular arc thread section, and the inside thereof has an internal thread section. The first insertion may be made of plastic materials or rubber materials; alternatively, the first insertion may be consisted by embracing a first metal screw with plastic materials or rubber materials.

In the dental implant package of the present invention, the healing abutment may be a one-piece type or a separation type. In an aspect of the present invention, the healing abutment which is a one-piece type comprises a tooth-replacement implant cap and a first insertion. Further, the tooth-replacement implant cap can comprise a first main body and a fist groove which is a polygonal prism with different sectional areas of upper level greater than low level and located in the main body, and an external surface of the first insertion may have a plane section and a first fine thread section. In another aspect of the present invention, the healing abutment which is a separation type comprises a tooth-replacement implant cap and a first insertion. Further, the tooth-replacement implant cap can comprise the first main body, a connecting section and a fine thread section; wherein the first main body is a cube and the connecting section is a column; therefore, the fine thread section and the first main body are connected by the connecting section. Further, the first insertion is a cylinder and the external surface thereof has a plurality of grooves.

In the dental implant package of the present invention, the first fine thread section on the first insertion of the healing abutment is joined to the internal thread section of the main body part to obtain an optimum mechanical connection and combination effect, thereby the dental implant package will not have liquid or bacteria present in slits.

In the dental implant package of the present invention, a diameter of the tooth-replacement implant cap may be randomly varied based on molding requirements or implant type. The diameter of the tooth-replacement implant cap may be greater than or equal to width of cross section of tooth to ensure that the tooth-replacement implant cap has enough volumes for cutting in subsequent step; wherein the width of cross section of tooth means that maximum width of tooth may be measured in a plurality of different section planes captured in random vectors. In the dental implant package of the present invention, the diameter of the tooth-replacement implant cap may be 3.0 mm to 7.0 mm, but the present invention is not limited thereto. In one aspect of the present invention, the diameter of the tooth-replacement implant cap may be 3.5 mm to 6 0 mm; in another aspect of the present invention, the diameter of the tooth-replacement implant cap may be 4.0 mm to 5.0 mm.

In the dental implant package of the present invention, a height of the tooth-replacement implant cap may be randomly varied based on molding requirements or implant type. The height of the tooth-replacement implant cap may be 1 mm-10 mm, but the present invention is not limited thereto. In one aspect of the present invention, the height of the tooth-replacement implant cap may be 3 mm to 8 mm; in another aspect of the present invention, the height of the tooth-replacement implant cap may be 5 mm to 6 mm.

In the dental implant package of the present invention, the composition of the healing abutment may be randomly varied based on the user's requirements or implant type. The healing abutment may be made of plastic materials or rubber materials, but the present invention is not limited thereto. In one aspect of the present invention, the healing abutment may be made of plastic materials; wherein the plastic materials may be polyether imide, polyethylene, polypropylene, polytetrafluoroethylene, ethylene terephthalate, polyamide, polyurethane, polysiloxane, polysiloxane elastomers, polyether ether ketone, polysulfone, polysaccharide or polylactic acid polymer; in one aspect of the present invention, the healing abutment may be made of polyether imide.

In the dental implant package of the present invention, the package may further comprise a cover screw; wherein the cover screw may further comprise a cone section and a second insertion. Further, the cone section may comprise a second groove which is a polygonal prism with different sectional areas of upper level greater than low level and located in the cone section. Further, an external surface of the second insertion may have a second fine thread section; wherein the second insertion may be made of plastic materials or rubber materials; alternatively, the second insertion may be consisted by embracing a second metal screw with plastic materials or rubber materials. Furthermore, the composition of the cover screw may be randomly varied based on the user's requirements or implant type, the cover screw may be made of plastic materials or rubber materials, but the present invention is not limited thereto. In one aspect of the present invention, the cover screw may be made of plastic materials; wherein the plastic materials may be polyether imide, polyethylene, polypropylene, polytetrafluoroethylene, ethylene terephthalate, polyamide, polyurethane, polysiloxane, polysiloxane elastomers, polyether ether ketone, polysulfone, polysaccharide or polylactic acid polymer; in one aspect of the present invention, the cover screw may be made of polyether imide.

In the dental implant package of the present invention, a diameter of the cover screw may be greater than or equal to width of cross section of tooth to ensure that the cover screw has enough volumes for cutting in subsequent step. In the dental implant package of the present invention, the second fine thread section on the cover screw is joined to the internal thread section of the main body part to obtain an optimum mechanical connection and combination effect, thereby the dental implant package will not have liquid or bacteria present in slits.

In the dental implant package of the present invention, the package further comprises a fixed abutment; wherein the fixed abutment may comprise a fixing section, a supporting section and a third insertion. The fixing section may comprise a third groove which is a polygonal prism with different sectional areas of upper level greater than low level and located in the fixing section. Further, an external surface of the third insertion may have a third fine thread section; wherein the third insertion may be made of plastic materials or rubber materials; alternatively, the third insertion may be consisted by embracing a third metal screw with plastic materials or rubber materials. Furthermore, the fixing section is a conical body, the supporting section is another conical body, and the fixing section and the third fine thread are combined by the supporting section. The composition of the fixed abutment may be randomly varied based on the user's requirements or implant type, the fixed abutment may be made of plastic materials or rubber materials, but the present invention is not limited thereto. In one aspect of the present invention, the fixed abutment may be made of plastic materials; wherein the plastic materials may be polyether imide, polyethylene, polypropylene, polytetrafluoroethylene, ethylene terephthalate, polyamide, polyurethane, polysiloxane, polysiloxane elastomers, polyether ether ketone, polysulfone, polysaccharide or polylactic acid polymer; in one aspect of the present invention, the fixed abutment may be made of polyether imide.

In the dental implant package of the present invention, the third fine thread section on the fixed abutment is joined to the internal thread section of the main body part to obtain an optimum mechanical connection and combination effect, thereby the dental implant package will not have liquid or bacteria present in slits. In the dental implant package of the present invention, the artificial tooth is inserted in the fixing section of the fixed abutment after inserting the fixed abutment into the tooth-replacement implant to complete an operation for dental implant.

In the dental implant package of the present invention, the package further comprises a ball-shaped abutment; wherein the ball-shaped abutment may comprise a ball-shaped section, a base and a fourth insertion, and an external surface of the fourth insertion has a fourth fine thread section. Further, the ball-shaped section has a ball body, a connecting section and a polygonal prism, and the ball-shaped are combined with the polygonal prism by the connecting section. Furthermore, the base is a conical body and the ball-shaped and the fourth insertion are combined by the base. Besides, the fourth insertion is made of plastic materials or rubber materials; alternatively, the fourth insertion may be consisted by embracing a fourth metal screw with plastic materials or rubber materials. The composition of the ball-shaped abutment may be randomly varied based on the user's requirements or implant type, the ball-shaped abutment may be made of plastic materials or rubber materials, but the present invention is not limited thereto. In one aspect of the present invention, the ball-shaped abutment may be made of plastic materials; wherein the plastic materials may be polyether imide, polyethylene, polypropylene, polytetrafluoroethylene, ethylene terephthalate, polyamide, polyurethane, polysiloxane, polysiloxane elastomers, polyether ether ketone, polysulfone, polysaccharide or polylactic acid polymer; in one aspect of the present invention, the ball-shaped abutment may be made of polyether imide.

In the dental implant package of the present invention, the fourth thread on the ball-shaped abutment is joined to the internal thread section of the main body part to obtain an optimum mechanical connection and combination effect, thereby the dental implant package will not have liquid or bacteria present in slits to avoid provisional from falling in the mouth.

In the dental implant package of the present invention, the plastic materials are allowed by U.S. Food and Drug Administration (FDA) as plastic materials for medical use, which has high mechanical strength, high hardness and fire resistance; further, the chemicals resistance, low temperature resistance and high temperature resistance thereof are all excellent. Besides, the plastic materials are non-toxicity and high bio-compatibility; therefore, the 3T3 fibroblast in gingival has good attachment with the plastic materials to accelerate wound healing of the gingival tissue.

In the dental implant package of the present invention, when the dental implant package is implanted into patient's mouth, the dental implant package may be molded to match gingival tissue because gingival of the patient's mouth is an irregular tissue. Further, an external surface of the dental implant package after molding may be a plane surface or a curved surface, so that gingival after healing is match with the external surface of the dental implant package.

In the dental implant package of the present invention, materials of the dental implant package and a provisional made of polymethylmethacrylate (PMMA) for clinical use have high compatibility; therefore, PMMA may be added clinically to mold gingival, and it is allowed that PMMA may be added to make a provisional by a dentist.

In the dental implant package of the present invention, the dental implant package may further comprise an additive material; wherein the additive material may be randomly varied based on the user's requirements, and the additive material may be metal materials. Further, the metal materials may be at least one selected from the group consisting of iron, copper, silver, cobalt, nickel, chromium, manganese, silicon, aluminum, and combinations thereof, but the present invention is not limited thereto. Besides, the dental implant package may show different colors because of adding different materials. The dental implant package show red color when the additive metal material is iron; the dental implant package show green color when the additive metal material is copper; and the dental implant package show white color when the additive metal material is silver. In the dental implant package of the present invention, the dental implant package after adding materials may show radiolucency or radiopaque during irradiating X-ray. In one aspect of the present invention, the dental implant package shows radiolucency during irradiating X-ray when the materials are not added in the dental implant package; and in another aspect of the present invention, the dental implant package after adding materials shows partial radiolucency or partial radiopaque during irradiating X-ray.

Presently the healing abutment made of metal in the market will cause artifacts after irradiating computer tomography (CT), magnetic resonance imaging (MRI) and X-ray, which affects interpretation of osseointegration between implant and bones. However, the dental implant package of the present invention has radiolucency, which does not affect image interpretation. Therefore, the dentist may identify that the position of the dental implant package is matched or not to avoid bacteria from breeding.

In the dental implant package of the present invention, the first insertion, the second insertion, the third insertion and the fourth insertion have a maximum torque which may be in a range of 20 Ncm to 60 Ncm, but the present invention is not limited thereto. In one aspect of the present invention, the maximum torque may be in a range of 20 Ncm to 50 Ncm. In the dental implant package of the present invention, the first fine thread on the first insertion, the second fine thread on the second insertion, the third fine thread on the third insertion and the fourth fine thread on the fourth insertion still may maintain itself effects to avoid breakage under maximum torque.

Further, presently the healing abutment made of metal in the market may release metal ion, but the materials used in the dental implant package of the present invention are quite different from prior art; therefore, the healing abutment of the present invention does not have a problem of release metal ion. Besides, the healing abutment made of metal in the market also has a problem of corrosion; however, the dental implant package of the present invention is not present a problem of corrosion because of specific materials properties.

Therefore, the effect of the present invention is to heal gingival tissues according to profile of the dental implant package, or maintain an enough space to insert a definitive prosthesis. Besides, the present invention can reduce significantly manufacturing cost and disposable medical equipment for one use is achieved to avoid cross infection. In summary, the technical feature of the present invention is to mold the dental implant package by general drilling tools and can adjust the dental implant package to suitable height, width and profile, thereby obtaining an emergency profile.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a schematic diagram of the dental implant package according to Example 1 of the present invention.

FIG. 2 shows a sectional diagram of the dental implant package according to Example 1 of the present invention.

FIG. 3 shows a schematic diagram of a combination of the first groove and a screw driver according to Example 1 of the present invention.

FIGS. 4a to 4c show a schematic diagram of different profiles of the tooth-replacement implant caps according to Example 2 of the present invention.

FIG. 5 shows a schematic diagram of a separation type healing abutment according to Example 3 of the present invention.

FIG. 6 shows a schematic diagram of a cover screw according to Example 4 of the present invention.

FIG. 7 shows a schematic diagram of a fixed abutment according to Example 5 of the present invention.

FIG. 8 shows a schematic diagram of a ball-shaped abutment according to Example 6 of the present invention.

### DETAILED DESCRIPTION OF THE PREFERRED EMBODIMENT

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention, and those skilled in the art will appreciate that various modifications, additions and substitutions are possible.

### Example 1

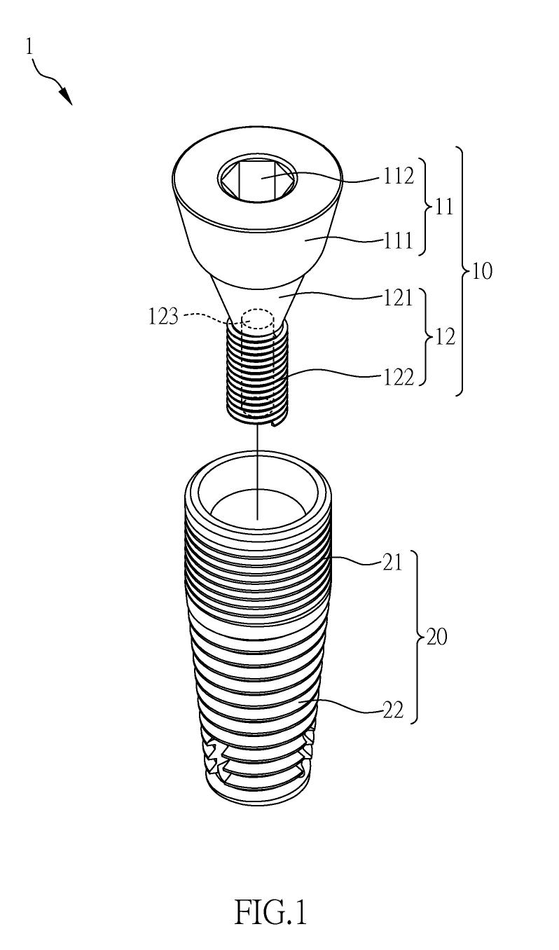

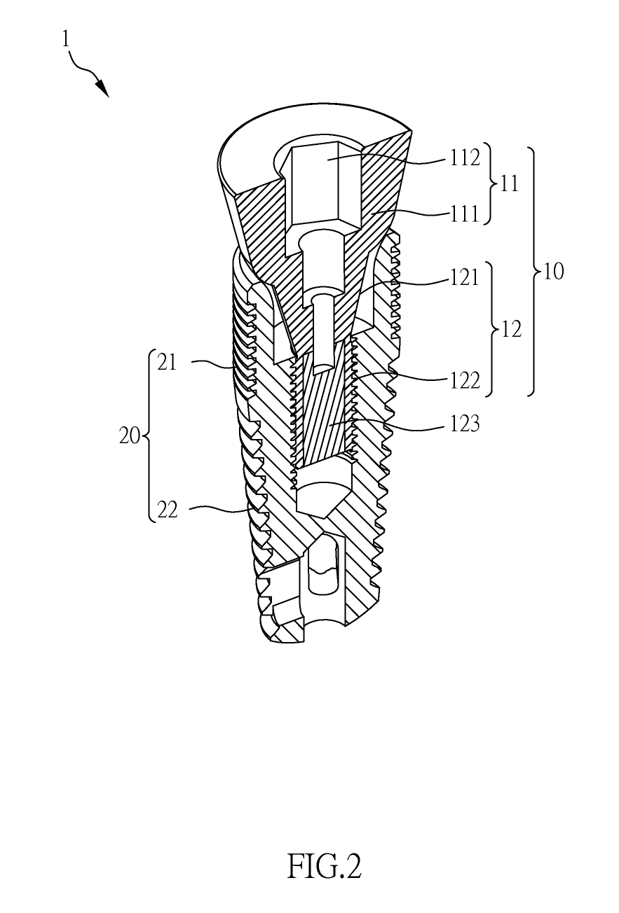

Please refer to FIGS. 1 and 2, FIG. 1 shows a schematic diagram of the dental implant package according to Example 1 of the present invention; and FIG. 2 shows a sectional diagram of the dental implant package according to Example 1 of the present invention. In the dental implant package 1 of the present invention, the dental implant package comprises a healing abutment 10 made of polyether imide and a tooth-replacement implant 20; wherein the healing abutment 10 comprises a tooth-replacement implant cap 11 and a first insertion 12. Further, a diameter the tooth-replacement implant cap 11 is 6.5 mm and a height thereof is 10 mm, and the tooth-replacement implant cap 11 comprises a main body 111 and a first groove 112 which located in the main body 111 formed by a conical body, and the first groove 112 is a hexagonal prism with different sectional areas of upper level greater than low level. Further, an external surface of the first insertion 12 has a plane section 121 and a first fine thread 122; wherein the first insertion 12 is consisted by embracing a first metal screw 123 with plastic materials or rubber materials. Besides, an external surface of the tooth-replacement implant 20 has an external thread section 21 and a circular arc thread section 22, and inside of the tooth-replacement implant 20 has an internal thread section; wherein the first fine thread of the first insertion 12 is joined to the internal thread section of the tooth-replacement implant 20; therefore, the dental implant package will not have liquid or bacteria present in slits. In the second stage of operation for dental implant, the healing abutment is inserted in the tooth-replacement implant 20 by the dentist; further, gingival tissues are healed according to profile of the healing abutment, and an enough space is maintained to insert a definitive prosthesis. The color of the healing abutment 10 of Example 1 of the present invention is amber similar to the color of gingival tissues; therefore, it can accomplish a beautiful effect.

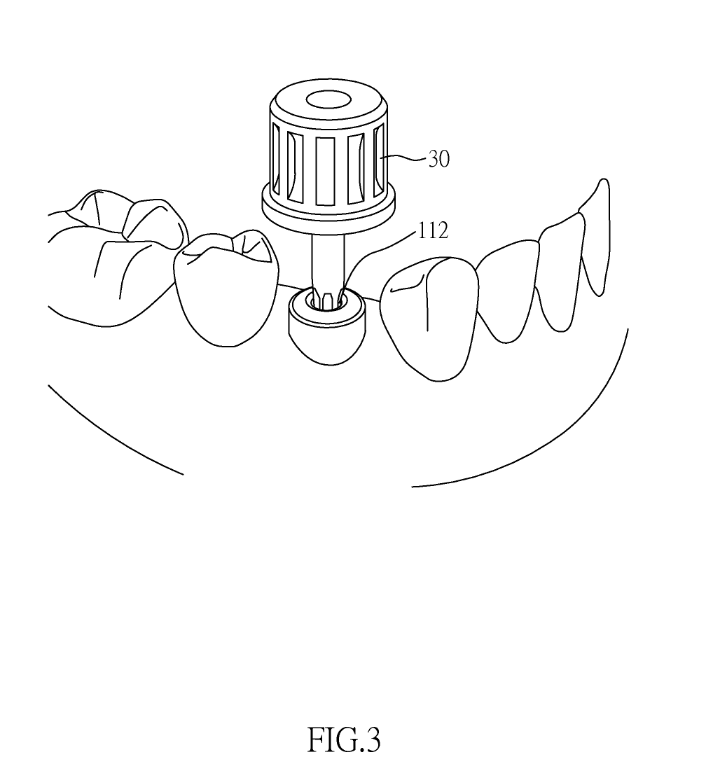

Please refer to FIG. 3, FIG. 3 shows a schematic diagram of a combination of the first groove and a screw driver according to Example 1 of the present invention. The first groove 112 of Example 1 of the present invention is a design of hexagonal prism with different sectional areas of upper level greater than low level; therefore, every kind of screw driver can used suitably in the first groove 112. Besides, the healing abutment 10 is disposable medical equipment for one use to avoid cross infection.

### Example 2

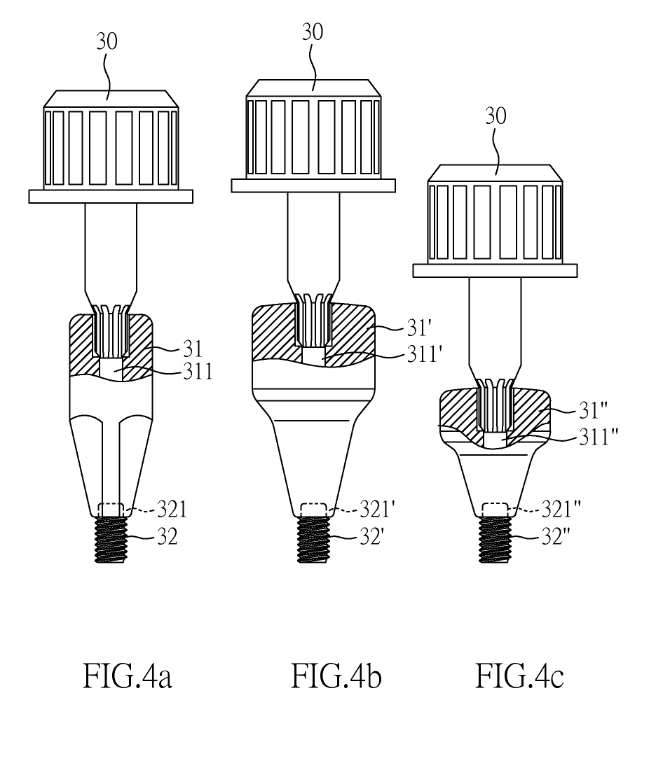

The dental implant package of Example 2 is substantially the same as the above Example 1, but profile of the tooth-replacement implant cap of Example 2 is different from profile of the tooth-replacement implant cap of Example 1. Please refer to FIGS. 4a to 4c, FIGS. 4a to 4c show a schematic diagram of different profiles of the tooth-replacement implant caps according to Example 2 of the present invention. The tooth-replacement implant cap 31 of FIG. 4a is a column; the tooth-replacement implant cap 31′ of FIG. 4b is a conical body; and the tooth-replacement implant cap 31″ of FIG. 4c is a screw-shaped body; therefore, the tooth-replacement implant cap may be randomly varied based on the user's requirements. Further, these tooth-replacement implant caps 31, 31′ and 31″ respectively comprise these first grooves 311, 311′ and 311″, and theses first grooves 311, 311′ and 311″ are designs for hexagonal prism with different sectional areas of upper level greater than low level; therefore, every kind of screw driver can used suitably in theses first grooves 311, 311′ and 311″. Furthermore, these first insertion 32, 32′ and 32″ are consisted by embracing a first metal screws 321, 321′ and 321″ with polyether imide materials; therefore, the screw driver 30 can insert directly into tops of these metal screws 321, 321′ and 321″ to lock these healing abutments.

### Example 3

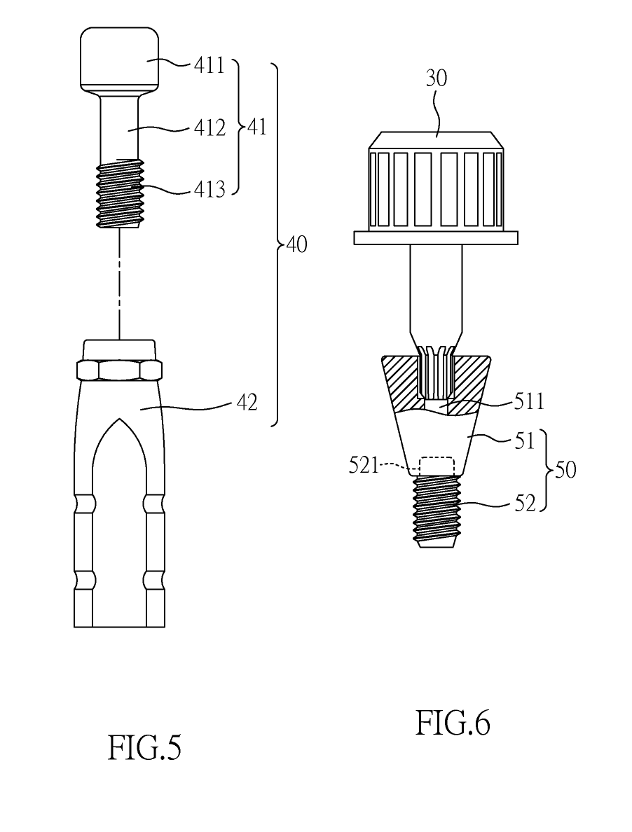

The dental implant package of Example 3 is substantially the same as the above Example 1, but the difference is that the healing abutment of Example 1 is one-piece type, and the healing abutment of Example 3 is a separation type. Please refer to FIG. 5, FIG. 5 shows a schematic diagram of a separation type healing abutment according to Example 3 of the present invention. The separation type healing abutment 40 is made of polyether imide, and comprises the tooth-replacement implant cap 41 and the first insertion 42; wherein the tooth-replacement implant cap 41 comprises a first main body 411 formed by a cube, the connecting section 412 formed by a column, and a fine thread section 413. Further, the first main body and the fine thread section 413 are connected by the connecting section 412, and the first insertion 42 which is a circular column has a plurality of grooves on surface thereof. The tooth-replacement implant cap 41 is locked completely into the first insertion 42; therefore, liquid or bacteria will not present in slits thereof.

### Example 4

The dental implant package of Example 4 is substantially the same as the above Example 1, but the difference is that the dental implant package of Example 1 is the healing abutment and the tooth-replacement implant, and the dental implant package of Example 4 is a cover screw and the tooth-replacement implant. Please refer to FIG. 6, FIG. 6 shows a schematic diagram of a cover screw according to Example 4 of the present invention. The cover screw 50 of Example 4 in made of polyether imide and comprises a cone section 51 and a second insertion 52; wherein the cone section 51 comprises a second groove 511 with a design for hexagonal prism with different sectional areas of upper level greater than low level; therefore, every kind of screw driver 30 can used suitably in the second groove. Further, an external surface of the second insertion 52 has a second fine thread section, and the second insertion 52 is consisted by embracing a second metal screw with polyether imide. The standard of the cover screw 50 may be randomly varied based on the user's requirements; wherein the second fine thread section of the second insertion 52 is joined to the internal thread section of tooth-replacement implant 20; therefore, liquid or bacteria will not present in slits thereof. Furthermore, gingival will be sutured to accomplish first stage of operation for dental implant.

### Example 5

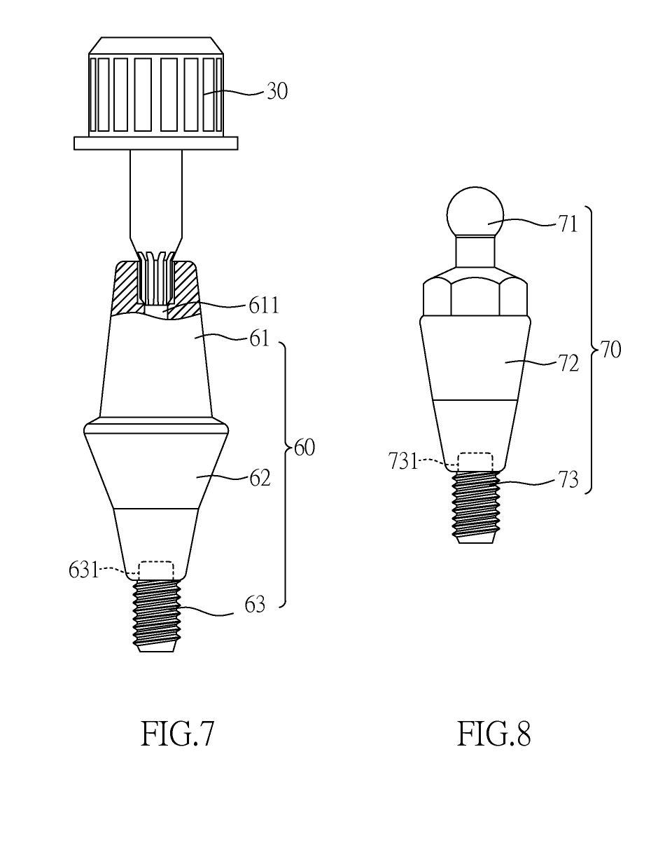

The dental implant package of Example 5 is substantially the same as the above Example 1, but the difference is that the dental implant package of Example 1 is the healing abutment and the tooth-replacement implant, and the dental implant package of Example 5 is a fixed abutment and the tooth-replacement implant. Please refer to FIG. 7, FIG. 7 shows a schematic diagram of a fixed abutment according to Example 5 of the present invention. The fixed abutment 60 of Example 5 is made of polyether imide and comprises a fixing section 61 formed by a conical body, a supporting section 62 formed by another conical body, and a third insertion 63. Further, the fixing section 61 comprises a third groove 611 which is designed as hexagonal prism with different sectional areas of upper level greater than low level; therefore, every kind of screw driver 30 can be used suitably in the third groove 611. Besides, an external surface of the third insertion 63 has a third fine thread section, and the third insertion 63 is consisted by embracing the third metal screw with polyether imide. Besides, the fixing section 61 and the third insertion 63 are connected by the supporting section 62, and the standard of the fixed abutment 60 may be randomly varied based on the user's requirements. Furthermore, the third fine thread section of the third insertion 63 is joined to the internal thread section of tooth-replacement implant 20; therefore, liquid or bacteria will not present in slits thereof. In the last stage of operation for dental implant, the healing abutment is took out by the dentist, and then the fixed abutment 60 is inserted and a provisional is inserted to the fixed abutment 60 to accomplish operation for dental implant.

### Example 6

The dental implant package of Example 6 is substantially the same as the above Example 1, but the difference is that the dental implant package of Example 1 is the healing abutment and the tooth-replacement implant, and the dental implant package of Example 6 is a ball-shaped abutment and the tooth-replacement implant. Please refer to FIG. 8, FIG. 8 shows a schematic diagram of a ball-shaped abutment according to Example 6 of the present invention. The ball-shaped abutment 70 is made of polyether imide and comprises a ball-shaped section 71, a base 72 formed by a conical body and a fourth insertion 73 whose external surface has a fourth fine thread section. Further, the ball-shaped section 71 comprises a ball body, a connecting section and a polygonal prism; wherein the ball body and the polygonal prism are connected by the connecting section, and the ball-shaped section 71 and the fourth insertion 73 are connected by the base 72. Besides, the fourth insertion 73 is consisted by embracing a fourth metal screw with polyether imide, and the standard of the ball-shaped abutment may be randomly varied based on the user's requirements. Furthermore, the fourth fine thread section on the fourth insertion 73 is joined to the internal thread section of the tooth-replacement implant 20; therefore, liquid or bacteria will not present in slits. The ball-shaped abutment 70 is usually used in a removable provisional, so that the removable provisional can be fixed on the tooth-replacement implant.

It should be understood that these examples are merely illustrative of the present invention and the scope of the invention should not be construed to be defined thereby, and the scope of the present invention will be limited only by the appended claims.

1. A dental implant package, comprising:
a healing abutment made of plastic materials or rubber materials and comprising a tooth-replacement implant cap and a first insertion; wherein the tooth-replacement implant cap includes a first main body and a first groove which is a polygonal prism with different sectional areas of upper level greater than low level and located in the main body, and an external surface of the first insertion has a plane surface and a first fine thread; and
a tooth-replacement implant whose an external surface has an external thread section and circular arc thread section;
wherein the first insertion is made of plastic materials or rubber materials; alternatively, the first insertion may be consisted by embracing a first metal screw with plastic materials or rubber materials.

2. The dental implant package of claim 1, further comprises a cover screw made of plastic materials or rubber materials and comprising a cone section and a second insertion; wherein the cone section includes a second groove which is a polygonal prism with different sectional areas of upper level greater than low level and located in the cone, and an external surface of the second insertion made of plastic materials or rubber materials has a second fine thread; alternatively, the second insertion is consisted by embracing a second metal screw with plastic materials or rubber materials.

3. The dental implant package of claim 2, further comprises a fixed abutment made of plastic materials or rubber materials and comprising a fixing section, a supporting section and a third insertion; wherein the fixing section includes a third groove which is a polygonal prism with different sectional areas of upper level greater than low level and located in fixing section, and an external surface of the third insertion mad of plastic materials or rubber materials has third fine thread section; alternatively, the third insertion is consisted by embracing a third metal screw with plastic materials or rubber materials.

4. The dental implant package of claim 3, further comprises a ball-shaped abutment made of plastic materials or rubber materials and comprising a ball-shaped section, a base and a fourth insertion made of plastic materials or rubber materials;
wherein an external surface of the fourth insertion mad of plastic materials or rubber materials has fourth fine thread section; alternatively, the fourth insertion is consisted by embracing a fourth metal screw with plastic materials or rubber materials.

5. The dental implant package of claim 1, wherein the plastic materials are polyether imide, polyethylene, polypropylene, polytetrafluoroethylene, ethylene terephthalate, polyamide, polyurethane, polysiloxane, polysiloxane elastomers, polyether ether ketone, polysulfone, polysaccharide or polylactic acid polymer.

6. The dental implant package of claim 1, further comprises a metal additive material.

7. The dental implant package of claim 6, wherein the metal additive material is at least one selected from the group consisting of iron, copper, silver, cobalt, nickel, chromium, manganese, silicon, aluminum, and combinations thereof.

8. The dental implant package of claim 4, wherein the first fine thread section of the first insertion, the second fine thread section of the second insertion, the third fine thread section of the third insertion and the fourth fine thread section of the fourth insertion are joined to the internal thread section of the tooth-replacement implant.

9. The dental implant package of claim 8, wherein the first insertion, the second insertion, the third insertion and the fourth insertion have a maximum torque in a a range of 20 Ncm to 60 Ncm.
